(19) United States
(12) Patent Application Publication
(10) Pub. No.: US 2025/0057158 A1
(43) Pub. Date: Feb. 20, 2025

(54) COMPOSITION FOR PROMOTING PLANT DISEASE RESISTANCE

(71) Applicant: CJ CHEILJEDANG CORPORATION, Seoul (KR)

(72) Inventors: Gun Chul SONG, Seoul (KR); Yeo Hong YUN, Seoul (KR); Mi Rong LEE, Seoul (KR); Ju Yeon SON, Seoul (KR)

(73) Assignee: CJ CHEILJEDANG CORPORATION, Seoul (KR)

(21) Appl. No.: 18/723,254

(22) PCT Filed: Dec. 22, 2022
(86) PCT No.: PCT/KR2022/021041

§ 371 Date: Jun. 21, 2024

(30) Foreign Application Priority Data
Dec. 22, 2021 (KR) 10-2021-0185259

(51) Int. Cl. A01N 37/04; A01N 43/36; A01N 43/50; A01P 1/00; A01P 3/00

(52) U.S. Cl. CPC A01N 37/04; A01N 43/36; A01N 43/50; A01P 1/00; A01P 3/00

(57) ABSTRACT

The present disclosure provides a composition including amino acids, a method of enhancing plant disease resistance using the same, a method of preventing or treating a plant disease, use in enhancing plant resistance, use in preventing or treating a plant disease, a composition including amino acids for controlling a plant disease, a method of controlling a plant disease using the same, and use in controlling a plant disease.

### TECHNICAL FIELD

The present disclosure relates to a composition for enhancing plant disease resistance, the composition including amino acids, a method of enhancing plant disease resistance using the same, a method of preventing or treating a plant disease, use in enhancing plant disease resistance, use in preventing or treating a plant disease, a composition for controlling a plant disease, the composition including amino acids, a method of controlling a plant disease using the same, and use in controlling a plant disease.

### BACKGROUND ART

Plants have developed signaling systems that effectively respond to changes in the external environment. For example, when a plant is exposed to a pathogen, resistance-related genes are expressed and signaling systems may be activated as resistance responses. In addition, jasmonic acid, ethylene, and salicylic acid, which are known as plant hormones, play a major role in transmitting disease resistance (induced resistance) from the site of infection to the plant systemically. Salicylic acid and jasmonic acid, either in their derivative forms or in their original form, move within the plant and induce systemic resistance responses. By inducing these systemic responses, resistance responses are induced not only in leaves invaded by pathogens but also throughout the entire plant that has not been invaded.

In this regard, derivatives that induce various resistance responses, in addition to pathogens, have been reported. Among them, benzo(1,2,3)-thiadiazile-7-carbothioic acid S-methyl ester (BTH, benzothiadiazole) is known as a substance exhibiting the most powerful effect. However, when BTH was treated, a serious problem was found, such as inhibition of plant growth or significant reduction of yields. According to later research, this problem was known to be due to a lack of energy for growth, as BTH consumes excessive energy in plants by expressing many resistance genes in plants even in the absence of pathogens. Therefore, there is an urgent need to develop a substance that has a similar effect to BTH in inducing systemic resistance responses and does not inhibit plant growth.

Further, agricultural and horticultural microbicide and insecticide including some compounds have been studied (U.S. Pat. No. 10,123,537 B2). However, the development of substances that induce systemic resistance responses without inhibiting plant growth is still insignificant.

### DISCLOSURE

### Technical Problem

The problem to be solved in the present disclosure is to provide a composition including amino acids for enhancing plant disease resistance, a method of enhancing plant disease resistance using the same, a method of preventing or treating a plant disease, use in enhancing plant disease resistance, use in preventing or treating a plant disease, a composition including amino acids for controlling a plant disease, a method of controlling a plant disease using the same, and use in controlling a plant disease.

### Technical Solution

An object of the present disclosure is to provide a composition for enhancing plant disease resistance, the composition including amino acids.

Another object of the present disclosure is to provide a method of enhancing plant disease resistance using the composition for enhancing plant disease resistance.

Still another object of the present disclosure is to provide a method of preventing or treating a plant disease using the composition for enhancing plant disease resistance.

Still another object of the present disclosure is to provide a composition for controlling a plant disease, the composition including amino acids.

Still another object of the present disclosure is to provide a method of controlling a plant disease using the composition for controlling a plant disease.

Still another object of the present disclosure is to provide use of the amino acids or the composition for enhancing plant disease resistance in enhancing plant disease resistance.

Still another object of the present disclosure is to provide use of the amino acids or the composition for controlling a plant disease in controlling the plant disease.

Still another object of the present disclosure is to provide use of the amino acids, the composition for enhancing plant disease resistance, or the composition for controlling a plant disease in preventing or treating the plant disease.

### Advantageous Effects

There is an effect of enhancing plant disease resistance by using amino acids.

### DESCRIPTION OF DRAWINGS

FIG. 1 shows results of investigating induced resistance of 10 kinds of amino acids in a plant model (Arabidopsis thaliana);

FIG. 2 shows results of deriving a valine concentration showing the most excellent induced resistance in a plant model;

FIG. 3 shows reduction of pathogens according to treatment of plant models with valine, proline, or isoleucine;

FIG. 4 shows observation of expression levels of disease resistance genes according to treatment of plant models with valine, proline, or isoleucine;

FIG. 5 shows disease control effects of valine or isoleucine treatment in soybeans, cucumbers, lettuce, rice, tomatoes, wheat, barley, and peppers;

FIG. 6 shows disease control effects of valine, proline, or isoleucine treatment in soybeans, cucumbers, and lettuce;

FIG. 7 shows results of examining induced resistance through a hyperspectral camera; and

FIG. 8 shows results of examining growth promoting ability of valine.

### DETAILED DESCRIPTION OF PREFERRED EMBODIMENTS

Hereinafter, the present disclosure will be described in detail as follows. Meanwhile, each description and embodiment disclosed in this disclosure may also be applied to other descriptions and embodiments. Further, all combinations of various elements disclosed in this disclosure fall within the scope of the present disclosure. Furthermore, the scope of the present disclosure is not limited by the specific description described below.

An aspect of the present disclosure provides a composition for enhancing plant disease resistance, the composition including amino acids.

There is provided a composition for enhancing plant disease resistance, wherein the amino acids may be any one or more selected from the group consisting of branched-chain amino acids, proline, glutamic acid, aspartic acid, and histidine, and the plant disease may be any one or more selected from the group consisting of leaf spot, bacterial soft rot, Phytophthora stem and root rot, bacterial leaf blight, and rice blast.

As used herein, the “branched-chain amino acid” refers to an amino acid having a branched alkyl group at a side chain, and includes valine, leucine, and isoleucine. Specifically, in the present disclosure, the branched-chain amino acid may be an L-branched-chain amino acid, and the L-branched-chain amino acid may be one or more selected from L-valine, L-leucine, and L-isoleucine, but is not limited thereto.

The proline may be L-proline, the glutamic acid may be L-glutamic acid, the aspartic acid may be L-aspartic acid, and the histidine may be L-histidine, but is not limited thereto.

In one embodiment, the amino acids of the present disclosure may be treated to a plant at a concentration of 0.0001% (w/w) to 10% (w/w), 0.0001% (w/w) to 5% (w/w), 0.0001% (w/w) to 1% (w/w), 0.005% (w/w) to 10% (w/w), 0.005% (w/w) to 1% (w/w), 0.005% (w/w) to 0.5% (w/w), 0.001% (w/w) to 10% (w/w), 0.001% (w/w) to 1% (w/w), 0.001% (w/w) to 0.5% (w/w), 0.01% (w/w) to 10% (w/w), 0.01% (w/w) to 1% (w/w), 0.01% (w/w) to 0.5% (w/w), 0.05% (w/w) to 10% (w/w), 0.05% (w/w) to 1% (w/w), 0.05% (w/w) to 0.5% (w/w), 0.1% (w/w) to 10% (w/w), 0.1% (w/w) to 1% (w/w), or 0.1% (w/w) to 0.5% (w/w) with respect to the total amount of the composition for enhancing plant disease resistance, a dilution thereof, or a concentrate thereof, but is not limited thereto.

The technical significance of the present disclosure is that use of amino acids, specifically, branched-chain amino acids, proline, glutamic acid, aspartic acid, and histidine, in enhancing plant disease resistance or controlling plant diseases is demonstrated.

In the present disclosure, the “plant disease” refers to a disease that occurs in a plant, and refers to abnormalities in its original appearance and physiological function. The cause of the disease may be disease injury caused by pathogens, nutrient deficiency in the soil, weather conditions, toxic gases, etc. The pathogen may be a fungal pathogen or a bacterial pathogen, but is not limited thereto.

Specifically, the plant disease of the present disclosure may be any one or more selected from the group consisting of leaf spot, bacterial soft rot, Phytophthora stem and root rot, bacterial leaf blight, and rice blast.

In the present disclosure, the “leaf spot” refers to a disease that causes large or small spots (or specks) on the stem, fruit, or leaves of a plant. The spots may be black, light brown, or brown. The leaf spot may occur in fruit vegetables, but it may occur without being limited to the type of plant. The leaf spot may be caused by several types of fungi or bacteria, and may be caused by a biotrophic pathogen, specifically, microorganisms of the genus Pseudomonas, more specifically, Pseudomonas syringae pv. tomato, much more specifically, Pseudomonas syringae pv.tomato DC3000, but is not limited thereto.

In the present disclosure, the “bacterial soft rot” refers to a disease in which the plant tissue decay occurs to cause a foul odor and rotting. Particularly, it is common in juicy vegetables such as lettuce and napa cabbage, and also appears in tomatoes, sweet potatoes, and potatoes. Thus, bacterial soft rot may occur without being limited to the type of plant. The bacterial soft rot may be caused by a necrotrophic pathogen, specifically, Pectobacterium carotovorum subsp. carotovorum, but is not limited thereto.

In the present disclosure, the “Phytophthora stem and root rot” is a type of fungal disease that occurs in potatoes or tomatoes, etc., and external symptoms are slightly different depending on the degree of infection. During the active growth period, the plant is stunted, the lower leaves appear reddish-brown, and young leaves may turn yellow to show various colors. When the infection is not severe, external symptoms are often unclear, and a diseased head produces small fruits and poor stolon. The Phytophthora stem and root rot may occur in fruit vegetables, but may occur without being limited to the type of plant. The Phytophthora stem and root rot is caused by a pathogen that is a fungus of the genus Phytophthora belonging to the family Pythiaceae of flagellated fungi, and may be specifically caused by Phytophthora sojae, but is not limited thereto.

In the present disclosure, the “bacterial leaf blight” refers to a disease in which the disease pattern appears as spots and turns brown. The disease pattern may be formed on leaves, stems, pods, petioles, and cotyledons, etc. It may occur without being limited to the type of plant, such as beans, mung beans, or fruit vegetables, etc. The leaf blight is caused by microorganisms of the genus Pseudomonas, specifically, Pseudomonas syringae pv. lachrymans, but is not limited thereto.

In the present disclosure, the “rice blast” is the most significant disease of grains, particularly, rice, and may occur in all parts of the grain. Lesions develop on above ground plant parts such as leaves, ears, ear branches, nodes, and rice grains, etc., but rice blast is the most common on leaves, ears, and ear branches. It is infected with conidia, and the common symptoms include red, gray, black, and/or brown irregular spots spreading on the leaves and the entire leaf turning brown and drying out. The ears or ear branches dry out to a light brown color and die, and when there is too much moisture, gray fungus grows on the surface. Dark brown disease patterns are formed at the nodes, and they are easily broken, and when the humidity is high, the surface may be covered with gray fungus. The rice blast may be caused by a microorganism of the genus Magnaporthe, specifically, Magnaporthe oryzae, but is not limited thereto.

In one embodiment, the plant disease may be caused by any one or more selected from the group consisting of Pseudomonas syringae pv. tomato, Pectobacterium carotovorum subsp. carotovorum, Phytophthora sojae, Pseudomonas syringae pv. lachrymans, and Magnaporthe oryzae, but is not limited thereto.

In one embodiment, the plant disease may be any one or more selected from the group consisting of leaf spot caused by Pseudomonas syringae pv. tomato, bacterial soft rot caused by Pectobacterium carotovorum subsp. carotovorum, soybean Phytophthora stem and root rot caused by Phytophthora sojae, cucumber bacterial soft rot caused by Pseudomonas syringae pv. lachrymans, lettuce bacterial soft rot caused by Pectobacterium carotovorum subsp. carotovorum, and rice blast caused by Magnaporthe oryzae, but is not limited thereto.

The plant disease may occur in any type of plant, but in one embodiment, the plant may be selected from the group consisting of legumes, fruit vegetables, leafy vegetables, and grains.

In the present disclosure, the “legumes” refers to a plant of the family Fabaceae which is used as foods or feeds. For example, soybeans, wild soybeans, kidney beans, black beans, peas, red beans, peanuts, cowpeas, etc. may be included. Specifically, the legumes may be soybeans, but are not limited thereto.

In the present disclosure, the “fruit vegetables” refers to vegetables intended for the use of fruit, based on the part of the vegetable used. For example, peppers, cucumbers, tomatoes, watermelons, strawberries, oriental melons, etc. may be included. Specifically, the fruit vegetables may be peppers, cucumbers, or tomatoes, but are not limited thereto.

In the present disclosure, the “leafy vegetables” refers to vegetables intended for the use of leaves, based on the part of the vegetable used. For example, napa cabbage, lettuce, perilla leaves, spinach, etc. may be included. Specifically, the leafy vegetables may be napa cabbage or lettuce, but are not limited thereto.

In the present disclosure, the “grains” refers to cultivated plants of the family Gramineae whose seeds are edible. For example, rice, wheat, barley, corn, etc. may be included. Specifically, the grains may be rice, wheat, or barley, but are not limited thereto.

In the present disclosure, the “plant disease resistance” refers to the property of preventing the invasion of pathogens, the property of preventing the development of a plant disease, and/or the property of not getting sick even when pathogens invade.

In a specific embodiment, the amino acids of the present disclosure may prevent or treat infection of plants with pathogens, and may cause systemic induced resistance in plants, but are not limited thereto.

In a specific embodiment, the amino acids of the present disclosure may enhance plant disease resistance, and at the same time, may not inhibit plant growth, but are not limited thereto. Specifically, as substances that induce plant disease resistance, pathogens as well as derivatives that induce various resistance responses are known, and some of the substances (e.g., benzo(1,2,3)-thiadiazole-7-carbothioic acid S-methyl ester, benzothiadiazole; BTH) have serious side effects such as inhibiting plant growth or significantly reducing yields. However, the amino acids of the present disclosure do not inhibit the plant growth, but rather may enhance the plant growth.

The composition for enhancing plant disease resistance of the present disclosure may include any agent or product needed to enhance plant disease resistance, such as pesticide preparations, fertilizers, control agents, etc., without limitation.

As used herein, the term “pesticide” refers to an agent used for the protection and growth of agricultural crops. Specifically, the pesticide may include preparations for use in controlling diseases, harmful insects, weeds, pathogens, nematodes, mites, etc. that occur during cultivation and storage of agricultural crops, as well as growth regulators for use in promoting or inhibiting the physiological functions of agricultural crops, and supplements for promoting remedial effects.

As used herein, the term “fertilizer”, also called manure, refers to a nutrient that fertilizes the soil and promotes the growth of plants. A fertilizer including the composition of the present disclosure may be easily used by mixing with the soil before sowing, and may be applied together when spraying pesticides, etc.

The composition for enhancing plant disease resistance of the present disclosure may further include substances which are included for enhancing disease resistance commonly used. In addition to the above amino acids, the composition may include, as an excipient, a pharmaceutically acceptable solid carrier, liquid carrier, liquid diluent, liquefied gas diluent, solid diluent or other auxiliaries, e.g., emulsifiers, dispersants, or surfactants such as foaming agents.

The composition for enhancing plant disease resistance of the present disclosure may be used after being formulated into an agricultural composition by mixing the active ingredient with the excipient, and as a method of formulating the agricultural composition, any method commonly used in the art may be applied.

Further, the composition for enhancing plant disease resistance of the present disclosure may be provided in the form of wettable powder, granules, powder, emulsion, spray, smoke agent, capsule, and gel, and may be provided in the form of a donut-shaped contact formulation for buoyancy of the composition, but is not limited to thereto.

In one embodiment, the composition of the present disclosure may be a composition for enhancing plant disease resistance or a composition for controlling a plant disease, the composition including valine, wherein the plant disease may be any one or more selected from the group consisting of leaf spot, bacterial soft rot, Phytophthora stem and root rot, bacterial leaf blight, and rice blast, but is not limited thereto.

In one embodiment, the composition of the present disclosure may be a composition for enhancing plant disease resistance or a composition for controlling a plant disease, the composition including isoleucine, wherein the plant disease may be any one or more selected from the group consisting of leaf spot, bacterial soft rot, Phytophthora stem and root rot, bacterial leaf blight, and rice blast, but is not limited thereto.

In one embodiment, the composition of the present disclosure may be a composition for enhancing leaf spot or bacterial soft rot resistance or a composition for controlling the plant disease, the composition including leucine, but is not limited thereto.

In one embodiment, the composition of the present disclosure may be a composition for enhancing leaf spot or bacterial soft rot resistance or a composition for controlling the plant disease, the composition including proline, but is not limited thereto.

In one embodiment, the composition of the present disclosure may be a composition for enhancing leaf spot resistance or a composition for controlling the plant disease, the composition including any one or more selected from the group consisting of glutamic acid, aspartic acid, and histidine, but is not limited thereto.

Another aspect of the present disclosure provides a method of enhancing plant disease resistance, the method including the step of treating a plant with the composition for enhancing plant disease resistance including amino acids.

In a specific embodiment, the method of enhancing plant disease resistance may promote plant growth, but is not limited thereto.

The amino acids, plant disease, plant disease resistance, and composition for enhancing plant disease resistance are as described in other aspects.

The plant includes all of plant parts, such as roots, stems, leaves, or combinations thereof, and plant types, without limitation. Specifically, the plant may be a plant individual at risk of being infected with a plant disease or infected with a pathogen, but is not limited thereto.

The treatment with the composition for enhancing plant disease resistance may be treatment by spraying, injecting, infusing, or mixing the composition onto the plant, or mixing the composition with the soil. However, as long as the inside or outside of the plant may be contacted with the composition directly or indirectly, it is not limited thereto. Further, the above treatment may be performed at the same time with or at the different time from invasion of a pathogen into the plant, and may be performed before or after invasion of a pathogen into the plant, but is not limited thereto.

The composition for enhancing plant disease resistance may be treated once or twice or more, but is not limited thereto. When treated twice or more, it may be treated at intervals of 3 days to 15 days, 3 days to 10 days, 3 days to 7 days, 4 days to 7 days, 5 days to 7 days, or 6 days, but is not limited thereto.

In one embodiment, the composition for enhancing plant disease resistance may be treated by primary treatment 7 days before pathogen invasion and by secondary treatment 1 day before pathogen invasion, but is not limited thereto.

In one embodiment, the plant may be any one or more selected from the group consisting of legumes, fruit vegetables, leafy vegetables, and grains, but is not limited thereto.

The legumes, fruit vegetables, leafy vegetables, grains, etc. are as described in other aspects.

Still another aspect of the present disclosure provides a method of preventing or treating a plant disease, the method including the step of treating a plant with the composition for enhancing plant disease resistance, the composition including amino acids.

The amino acid, plant disease, plant disease resistance, composition for enhancing plant disease resistance, treatment with the composition for enhancing plant disease resistance, and plant are as described in other aspects.

In the present disclosure, the term “preventing” means all actions by which the occurrence of a plant disease or development thereof is restrained or retarded.

In the present disclosure, the term “treating” means all actions by which a plant disease has taken a turn for the better or been modified favorably. In the present disclosure, the treating may include all actions by which infection with a plant disease pathogen or recurrence of a plant disease is prevented, symptoms are alleviated, the rate of progression is reduced, the disease state is relieved, the disease state is temporarily or continuously alleviated or mitigated, or the prognosis is improved.

Still another aspect of the present disclosure provides a composition for controlling a plant disease, the composition including amino acids, wherein the amino acid is any one or more selected from the group consisting of branched-chain amino acids, proline, glutamic acid, aspartic acid, and histidine, and the plant disease is any one or more selected from the group consisting of leaf spot, bacterial soft rot, Phytophthora stem and root rot, bacterial leaf blight, and rice blast.

The amino acid, plant disease, etc. are as described in other aspects.

As used herein, the term “disease control” means preventing plants, such as crops, from being damaged by diseases and pests, removing pathogens that have occurred, or preventing the spread of pathogens. The disease control is a series of actions to reduce damage caused by pests, and may include physical (mechanical) control methods, agronomical control methods, chemical control methods, biological control methods, and eco-friendly control methods, but is not limited thereto. The disease control includes not only chemical control of using microbicides or insecticides which are toxic to pests, but also a method of creating an environment unsuitable for pathogens by cultivation of resistant plants, crop rotation, etc., a method of removing pathogens by heat treatment of plants or steam treatment of soil, a method of attracting and killing pests using attractants or sex pheromones.

The composition for controlling a plant disease of the present disclosure includes any agent or product needed to control the plant disease, such as pesticide preparations, fertilizers, control agents, etc., without limitation.

The composition for controlling a plant disease of the present disclosure may further include substances which are included for controlling a disease commonly used. In addition to the above amino acids, the composition may further include, as an excipient, a pharmaceutically acceptable solid carrier, liquid carrier, liquid diluent, liquefied gas diluent, solid diluent or other auxiliaries, e.g., emulsifiers, dispersants, or surfactants such as foaming agents.

The composition for controlling a plant disease of the present disclosure may be used after being formulated into an agricultural composition by mixing the active ingredient with the excipient, and as a method of formulating the agricultural composition, any method commonly used in the art may be applied.

Further, the composition for controlling a plant disease of the present disclosure may be provided in the form of wettable powder, granules, powder, emulsion, spray, smoke agent, capsule, and gel, and may be provided in the form of a donut-shaped contact formulation for buoyancy of the composition.

Still another aspect of the present disclosure provides a method of controlling a plant disease, the method including the step of treating a plant body with a composition for controlling a plant disease, the composition including amino acids. Specifically, the method of controlling a plant disease may promote plant growth.

The amino acids, plant, plant body, plant disease, disease control, composition for controlling a plant disease, etc. are as described in other aspects.

The treatment with the composition for controlling a plant disease may be treatment by spraying, injecting, infusing, or mixing the composition onto the plant body, or mixing the composition with the soil. However, as long as the inside or outside of the plant body may be contacted with the composition, it is not limited thereto. Further, the above treatment may be performed at the same time with or at the different time from invasion of a pathogen into the plant, and may be performed before or after invasion of a pathogen into the plant, but is not limited thereto.

The composition for controlling a plant disease may be treated once or twice or more, but is not limited thereto. When treated twice or more, it may be treated at intervals of 3 days to 15 days, 3 days to 10 days, 3 days to 7 days, 4 days to 7 days, 5 days to 7 days, or 6 days, but is not limited thereto.

In one embodiment, the composition for controlling a plant disease may be treated by primary treatment 7 days before pathogen invasion and by secondary treatment 1 day before pathogen invasion, but is not limited thereto.

Still another aspect of the present disclosure provides use of the amino acids or the composition including the same in enhancing plant disease resistance; use in controlling a plant disease; and use in preventing or treating a plant disease.

The amino acids, plant disease, plant disease resistance, disease control, preventing, treating, etc. are as described in other aspects.

### MODE FOR CARRYING OUT THE INVENTION

Hereinafter, the present disclosure will be described in more detail by way of exemplary embodiments. However, the following exemplary embodiments are only preferred embodiments for illustrating the present disclosure, and thus are not intended to limit the scope of the present disclosure thereto. Meanwhile, technical matters not described in the present specification can be sufficiently understood and easily implemented by those skilled in the technical field of the present disclosure or similar technical fields.

### Example 1. Verification of Induced Resistance of Amino Acids Against Plant Disease

To verify induced resistance of various amino acids against plant diseases, a plant model Arabidopsis thaliana was used, and as pathogens, Pseudomonas syringae pv. tomato DC3000 (hereinafter, referred to as Pst) known to cause leaf spot and Pectobacterium carotovorum subsp. carotovorum SCC1 (hereinafter, referred to as Pcc) known to cause bacterial soft rot were used.

To grow the plant model, the surface of Arabidopsis thaliana seeds was sterilized by immersing them in 3% sodium hypochlorite (NaOCl) for 5 minutes. Thereafter, the seeds were rinsed five times using sterile water and then sown on 1/2 Murashige and Skoog (MS) medium (0.6% agar, 1.5% sucrose, pH 5.8). 3 days later, when the seeds germinated, each six of the germinated seeds were transplanted onto plates (Falcon, USA) and cultured in a plant incubator (a light condition of 12 hours and a temperature condition of 23° C.).

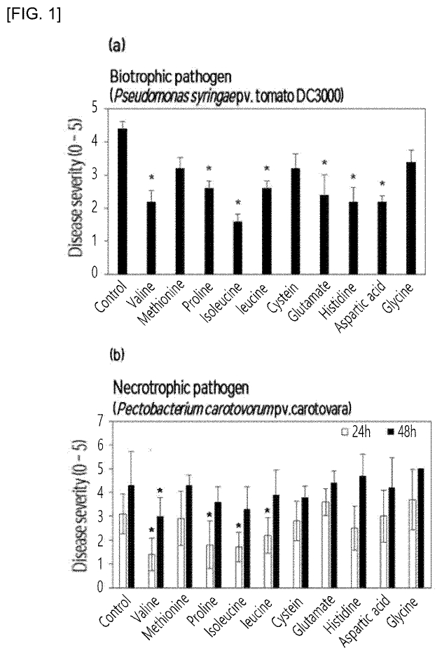

Two weeks after transplanting, 50 μl of each of 10 amino acids at a concentration of 0.1% was applied to the roots of each plant body. 7 days after amino acid treatment, five leaves of each plant body were treated with each 2 μl of 1×10⁸ cfu/ml of Pst (biotrophic, FIG. 1A) and Pcc (necrotrophic, FIG. 1B) pathogens.

The Pst pathogen was cultured at 30° C. for 48 hours on a King's B (KB) solid medium before treatment. With regard to the Pst pathogen, disease severity was observed 7 days after treatment with the pathogen, and the disease severity of each leaf was scored from 0 to 5, based on the following criteria, and the average value was calculated;
0=no symptoms, 1=mild chlorosis symptoms, 2=chlorosis symptoms, 3=chlorosis symptoms and mild necrosis, 4=necrosis and 5=severe necrosis symptoms.

The Pcc pathogen was cultured at 30° C. for 48 hours on a Luria-Bertani broth (LB) solid medium before treatment. With regard to the Pcc pathogen, disease severity of each leaf was observed 24 hours and 48 hours after treatment with the pathogen, and the disease severity was scored from 0 to 5, based on the following criteria, and the average value was calculated;
0=no symptoms, 1=slight soft rot symptoms at the pathogen infection site, 2=soft rot symptoms at the pathogen infection site, 3=severe soft rot symptoms at the pathogen infection site, 4=soft rot symptoms around the pathogen infection site, 5=soft rot symptoms throughout the leaf.

Amino acids showing the induced resistance effects against diseases were selected as having statistical significance, as compared to a water-treated control group.

As a result, it was confirmed that seven amino acids of valine, proline, isoleucine, leucine, glutamic acid, histidine, and aspartic acid induced the resistance against Pst (FIG. 1A), and four amino acids of valine, proline, isoleucine, and leucine induced the resistance against Pcc (FIG. 1B).

In particular, it was confirmed that valine's disease resistance persisted even after 48 hours of Pcc pathogen treatment. It was also confirmed that valine, proline, isoleucine, and leucine cause induced resistance against both the biotrophic pathogen Pst and the necrotrophic pathogen Pcc in plants.

### Example 2. Additional Verification of Amino Acids That Cause Induced Resistance Against Plant Disease

The induced resistance effect was confirmed again using valine which showed the best induced resistance against Pcc and Pst in Example 1.

Valine was used at concentrations of 0.5%, and 0.1%, 0.05%, 0.01%, 0.005% and 0.001%, and Pst was used as the pathogen. All other methods are the same as the experimental method in Example 1.

As a selection criterion, it was evaluated whether groups treated with different concentrations of valine showed a statistical difference (p<0.05) in the induced resistance against disease, as compared to a water-treated group.

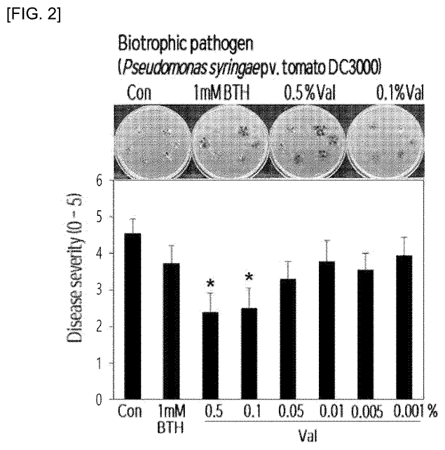

As a result, overall disease severity decreased in the valine-treated groups, and furthermore, the 0.5% and 0.1% (0.95 mM) valine-treated groups showed a disease severity of 2.4 and 2.5, respectively, whereas a disease severity of the water-treated group reached 4.6, indicating that the disease severity in both the 0.5% and 0.1% (0.95 mM) valine-treated groups was significantly reduced. The 1 mM BTH-treated group, BTH known as an induced resistance substance, showed a disease severity of 3.7, indicating that the 0.5% and 0.1% valine-treated groups had more excellent disease resistance effect than the BTH-treated group (FIG. 2).

### Example 3. Verification of Induced Resistance by Valine and Isoleucine Treatment

Proline, and valine and isoleucine among branched-chain amino acids (BCAA) were used to verify whether induced resistance reduces the number of pathogens.

To this end, a plant was prepared in the same manner as in Example 1, and treated with amino acids (0.1% valine, 0.1% isoleucine, and 0.1% proline were selected, which were confirmed in Example 2 to have the induced resistance effect at low concentrations) and pathogens.

The number of pathogens was measured by placing the parts of Arabidopsis thaliana, excluding the roots, in an e-tube containing beads, grinding them, and then examining the pathogens contained in the juice.

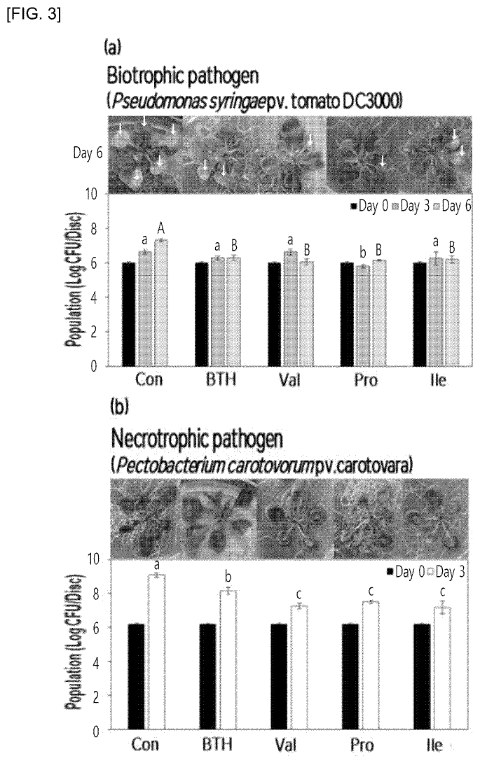

As a result of measuring the number of pathogens on days 3 and 6 after treating the Arabidopsis thaliana plant body with the Pst pathogen, it was confirmed that the 0.1% valine-treated group, 0.1% isoleucine-treated group, and 0.1% proline-treated group showed a statistically significant reduction in the number of pathogens on day 6, as compared to the untreated control group (FIG. 3A).

As a result of measuring the number of pathogens on day 3 after treating the Arabidopsis thaliana plant body with the Pcc pathogen, it was confirmed that the 0.1% valine-treated group, 0.1% isoleucine-treated group, and 0.1% proline-treated group showed a reduction in the number of Pcc pathogen, as compared to the untreated control group. It was confirmed that the valine, isoleucine, and proline-treated groups also showed a reduction in the number of pathogens, as compared to the BTH-treated group (FIG. 3B).

### Example 4. Verification of Gene Expression Response Related to Plant Disease Resistance

To examine whether or not valine, isoleucine, and proline induce the expression of disease resistance-related genes, Arabidopsis thaliana (Denoux et al., Molecular Plant, Volume 1, Number 3, pages 423-445, May 2008) containing Pathogenesis-related protein (PR) 1a promoter GUS fusion construct which is a disease resistance marker gene was used. An Arabidopsis thaliana plant was prepared in the same manner as in Example 1, and the roots of Arabidopsis thaliana were treated with 50 μl of valine, 50 μl of isoleucine, or 50 μl of proline, respectively. One week after treatment, the expression of the resistance marker gene PR1a was observed through GUS (β-glucuronidase; GUS reporter) activity.

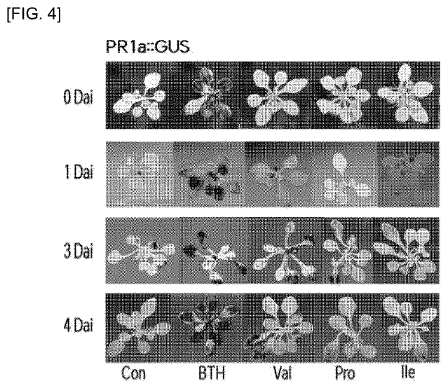

As a result of observation from 1 day after inoculation (Dai) to 4 Dai after pathogen treatment, it was confirmed that GUS was expressed in the leaf area not only in the BTH-treated group but also in the valine, isoleucine, and proline-treated groups, indicating PR1a expression (FIG. 4).

### Example 5. Verification of induced resistance of valine and isoleucine through pot experiment

Disease resistance was verified again with respect to crops grown in pots.

The surfaces of seeds of eight crops were sterilized by immersing them in 3% sodium hypochlorite (NaOCl) for 5 minutes, respectively. Thereafter, the seeds were rinsed five times using sterile water and then sown in a pot containing bed soil and cultured in a plant incubator (12 hours of light and 23° C. temperature). After growing in pots in the plant incubator (12-hour light culture, 26° C. vision) for 3 weeks, 5 ml of each amino acid was sprayed at a concentration of 0.1%. One day after amino acid treatment, pathogens were inoculated as follows, and the control value was calculated.

The procedure was conducted on 9 pathogens for a total of 8 crops (soybean, cucumber, lettuce, rice, tomato, wheat, barley, and pepper), and the target pathogens are as follows: soybean Phytophthora stem and root rot (Phytophthora sojae), cucumber bacterial leaf blight (Pseudomonas syringae pv. lachrymans), lettuce bacterial soft rot (Pectobacterium carotovorum pv. carotovora), rice blast (Magnaporthe oryzae), tomato gray mold (Botrytis cinerea), tomato late blight (Phytophthora infestans), wheat leaf rust (Puccinia recondite), barley powdery mildew (Blumeria graminis f. sp. hordei), and pepper anthracnose (Colletotrichum coccodes).

### a) Soybean Phytophthora Stem and Root Rot

Phytophthora sojae strain which is a pathogen of soybean Phytophthora stem and root rot was inoculated in a V8 medium (V8 juice, 1.8% agar); and cultured in an incubator at 25° C. for 2 weeks, and the formed spores were harvested with sterile distilled water to prepare a spore suspension (5.0×10⁵ spores/ml). Soybeans, which were inoculated with the prepared spore suspension by spraying 5 ml thereof per plant, were allowed to develop the disease for 3 days in a constant temperature and humidity room at a temperature of 26° C., and then a diseased area (%) was examined. The diseased area was calculated as follows.

Diseased area=Sum of area of diseased leaves/Sum of total leaf area examined×100%

### b) Cucumber Bacterial Leaf Blight

Pseudomonas syringae pv. lachrymans strain which is a pathogen of cucumber bacterial leaf blight was cultured on a King's B (KB) solid medium at 28° C. for 48 hours. 5 ml of the pathogen per plant was treated at a concentration of OD=1 (10⁹ CFU/ml) by spraying. The inoculated cucumbers were allowed to develop the disease for 3 days in a constant temperature and humidity room at a temperature of 26° C., and then a diseased area (%) was examined.

### c) Lettuce Bacterial Soft Rot

Pectobacterium carotovorum pv. carotovora strain which is a pathogen of lettuce bacterial soft rot was cultured on a Luria-Bertani broth (LB) solid medium at 28° C. for 48 hours. Lettuces were treated with 5 ml of the pathogen per plant at a concentration of OD=1 (10⁹ CFU/ml) by spraying. The inoculated lettuces were allowed to develop the disease for 1 day in a constant temperature and humidity room at a temperature of 26° C., and then a diseased area (%) was examined.

### d) Rice Blast

Magnaporthe oryzae KI-1113a strain which is a pathogen of rice blast (RCB) was inoculated on a rice polish agar; and cultured in an incubator at 25° C. for 2weeks, and the formed spores were harvested with sterile distilled water to prepare a spore suspension (5.0×10⁵ spores/ml). Rices, which were inoculated by spraying 5 ml thereof per plant, were left in the dark in a humid room for 24 hours, and allowed to develop the disease for 4 days in a constant temperature and humidity room with a relative humidity of 80% and a temperature of 25° C., and then a diseased area (%) was examined.

### e) Tomato Gray Mold

Botrytis cinerea strain which is a pathogen of tomato gray mold (TGM) was inoculated on a potato agar medium; and cultured in an incubator (dark condition) at 20° C., and the formed spores were used as an inoculum. For pathogen inoculation, spores were harvested and the spore concentration was prepared at 5.0×10⁵ spores/ml using a hemocytometer, followed by spraying onto the sample-treated tomato seedlings (2^{nd} to 3^{rd} leaf stage). The inoculated tomato seedlings were left in a humid room (relative humidity of 95% or more) at 20° C. to develop the disease for 3 days, and then a diseased area (%) was examined.

### f) Tomato Late Blight

Phytophthora infestans strain which is a pathogen of tomato late blight (TLB) was inoculated on an oatmeal medium; and cultured in an incubator at 20° C. to form zoosporangia. The formed zoosporangia were harvested by adding sterile distilled water to prepare a spore suspension with a spore concentration of 2.0×10⁴ sporangia/ml, which was treated at low temperature in a refrigerator to release zoospores, thereby preparing a zoospore suspension. The zoospore suspension was spray-inoculated onto sample-treated tomato seedlings (2^{nd} to 3^{rd} leaf stage). Tomato seedlings inoculated with pathogens were treated in a humid room at 20° C. for 2 days and were allowed to develop the disease for 2 days in a constant temperature and humidity room, and then a diseased area (%) was examined.

### g) Wheat Leaf Rust

Puccinia recondite which is a pathogen of wheat leaf rust (WLR) is a biotrophic pathogen, and thus while performing direct subculture, spores (urediniospores) formed on wheat leaves were used as an inoculum. To investigate the medicinal efficacy, 5 grains of wheat seeds ('Geumgang wheat') were sown in disposable pots (diameter: 4.5 cm), and 1-leaf seedlings grown in a greenhouse for 8 days were treated with samples, and 1 day later, the inoculum (0.67 g/L spores) was inoculated by spraying. The inoculated wheat seedlings were treated in a humid room at 20° C. for 1 day, and then transferred to a constant temperature and humidity room with a relative humidity of 70% at 20° C. to induce disease development. 7 days after inoculation, a diseased area (%) was examined.

### h) Barley Powdery Mildew

Blumeria graminis f. sp. hordei which is a pathogen of barley powdery mildew (BPM) is a biotrophic pathogen, and thus while performing subculture of barley seedlings, spores formed on barley leaves were used as an inoculum. To investigate the medicinal efficacy, 5 grains of barley seeds ('Hanyoung barley') were sown in disposable pots (diameter: 4.5 cm), and 1-leaf seedlings grown in a greenhouse for 8 days were treated with samples, and air-dried in a greenhouse, and powdery mildew spores were shaken off and inoculated into the sample-treated barley. The inoculated barley seedlings were left in a constant temperature and humidity room with a relative humidity of 50% at 20° C. to induce disease development for 7 days. Then, a diseased area (%) was examined.

### i) Pepper Anthracnose

Colletotrichum coccodes which is a pathogen of pepper anthracnose (PAN) was inoculated on an oatmeal medium; and cultured at 25° C. for 10 days to form spores. The formed spores were harvested and adjusted to a spore concentration of 5×10⁵ spores/ml to prepare a spore suspension. The spore suspension was spray-inoculated onto sample-treated pepper seedlings (3^{rd} to 4^{th} leaf stage), and left in a humid room (25° C.) and treated in a humid room for 2 days, and then were allowed to develop the disease in a constant temperature and humidity room (25° C. 80% RH). 3 days after inoculation, a diseased area (%) on the pepper leaves was examined.

From the diseased areas examined as in a) to i), control values were calculated according to the following Equation.

$$Control value ( \% ) = ( 1 - Diseased area of treated group / Diseased area of untreated group ) \times 100$$

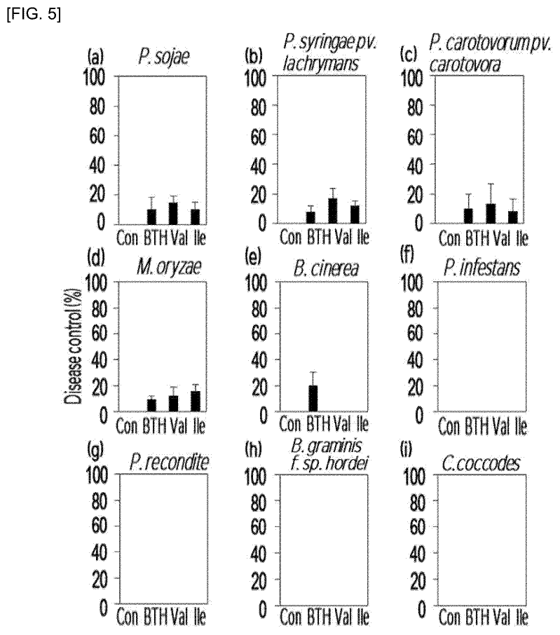

As a result, when induced resistance was tested for 9 pathogens, the control effects were observed in soybean Phytophthora stem and root rot (FIG. 5A), cucumber bacterial leaf blight (FIG. 5B), lettuce bacterial soft rot (FIG. 5C), and rice blast (FIG. 5D), as compared to the untreated group.

The control values of the valine-treated group and the isoleucine-treated group were 15% and 10% for soybean Phytophthora stem and root rot, 17% and 12% for cucumber bacterial leaf blight, 13% and 8% for lettuce bacterial soft rot, and 13% and 16% for rice blast, respectively, as compared to the untreated group.

The control values for soybean Phytophthora stem and root rot, cucumber bacterial leaf blight, lettuce bacterial soft rot, and rice blast were 10%, 9%, 10%, and 9% in the BTH-treated group, which is an induced resistance substance, respectively, as compared to the untreated group. Further, the control values for tomato gray mold was 20% in the BTH-treated group, as compared to the untreated group. In order to increase the induced resistance effect against the pathogens being controlled, the following experiments according to the treatment time and method were conducted.

### Example 6. Investigation of Optimal Conditions for Induced Resistance of Valine and Isoleucine

To increase the disease control value by valine and isoleucine, the period of induced resistance was changed. A total of 3 crops (soybean, cucumber, lettuce) were tested against 3 pathogens (soybean Phytophthora stem and root rot, cucumber bacterial leaf blight, lettuce bacterial soft rot), and each plant was prepared in the same manner as Example 5.

With regard to the pathogen of soybean Phytophthora stem and root rot, disease severity was observed 7 days after treatment with the pathogen, and the disease severity was scored from 0 to 5, based on the following criteria; 0=no symptoms, 1=1 foliage leaf withered, 2=2 foliage leaves withered, 3=3 foliage leaves withered, 4=4 foliage leaves withered, and 5=severe withering of the entire plant.

With regard to the pathogen of cucumber bacterial leaf blight, disease severity was observed 7 days after treatment with the pathogen, and the disease severity was scored from 0 to 5, based on the following criteria; 0=no symptoms, 1=mild disease symptoms, 2=30% disease symptoms, 3=disease symptoms and mild necrosis, 4=necrosis and 5=severe necrosis and withering.

With regard to the pathogen of lettuce bacterial soft rot, disease severity was observed 48 hours after treatment with the pathogen, and the disease severity was scored from 0 to 5, based on the following criteria; the disease severity was determined according to the criteria of 0=no symptoms, 1=slight soft rot symptoms at the pathogen infection site, 2=soft rot symptoms at the pathogen infection site, 3=severe soft rot symptoms at the pathogen infection site, 4=soft rot symptoms around the pathogen infection site, 5=soft rot symptoms throughout the leaf.

From the disease severity investigated in this manner, a control value was calculated according to the following Equation.

$$Control value ( \% ) = ( 1 - Disease severity of treated group / Disease severity of untreated group ) \times 100$$

In order to derive the optimal control value for induced resistance, various amino acid treatment periods and frequencies were tested, and ultimately, the first amino acid treatment conducted 7 days before the pathogen treatment and the secondary treatment conducted 1 day before the pathogen treatment resulted in the most excellent induced resistance effect.

The results of the first amino acid treatment 7 days before the pathogen treatment and the second treatment 1 day before the pathogen treatment were as follows.

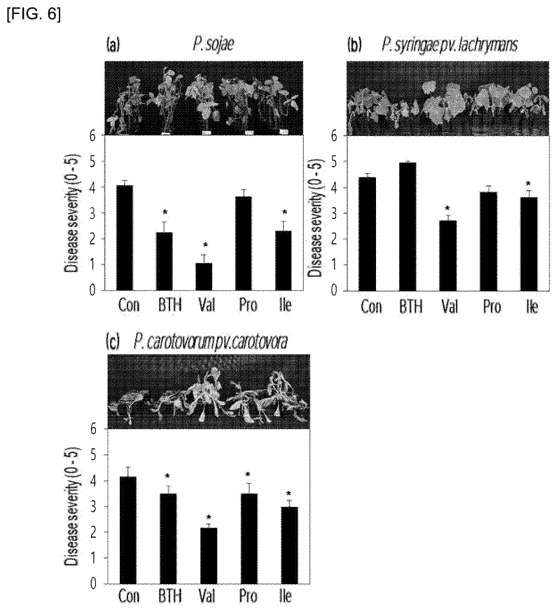

With regard to soybean Phytophthora stem and root rot, the disease severity in the valine-treated group and the isoleucine-treated group was 1.1 and 2.3, respectively, which was lowered, as compared to 4.1 in the water control group. The control values were calculated as 73% and 44%, respectively, compared to the untreated group. It was confirmed that valine induced the better disease control effect than the BTH-treated group, which had a control value of 46%, and isoleucine had the similar control effect as the BTH-treated group (FIG. 6A).

With regard to cucumber bacterial leaf blight, the disease severity in the valine-treated group and the isoleucine-treated group was 2.7 and 3.6, respectively, which was lowered, as compared to 4.4 in the water control group. The control values were calculated as 39% and 18%, respectively, compared to the untreated group. In contrast, it was confirmed that not only disease susceptibility but also growth were inhibited in the BTH-treated group, as compared to the untreated group. Valine and isoleucine have the disease control effect by causing induced resistance against cucumber bacterial leaf blight. Unlike the BTH-treated group that showed growth inhibition when causing induced resistance, no growth inhibition phenomenon was observed in the valine or isoleucine-treated group (FIG. 6B).

With regard to lettuce bacterial soft rot, the disease severity in the valine-treated group and the isoleucine-treated group was 2.2 and 3, respectively, which was lowered, as compared to 4.2 in the water control group. The control values were calculated as 48% and 29%, respectively, compared to the untreated group. The results suggest that the valine-treated group and the isoleucine-treated group had the better disease control effect than the BTH-treated group, which had a control value of 17% (FIG. 6C).

### Example 7. Verification of Induced Resistance via Hyperspectral Camera

The induced resistance against Soybean Phytophthora stem and root rot was investigated using a hyperspectral camera and a visible light band camera. Plant preparation was carried out in the same manner as in Example 6, and 7 days after disease treatment, leaves were picked from the same position in each treatment group, and hyperspectral photographs were taken. The hyperspectral camera captured images in the wavelength range of 400 nm to 1000 nm, taking advantage of the fact that healthy and diseased leaves have different wavelength bands, which can be displayed in color. Even when it is difficult to distinguish differences in disease severity with the naked eye, the hyperspectral camera makes it easy.

It was quantified by the normalized difference vegetation index (NDVI). The degree of diseased leaves in the entire leaf area was indicated from 0.1 to 0.9 and the number of the corresponding pixels was used. Generally, when the number is 0.7 or more, it is considered a healthy leaf.

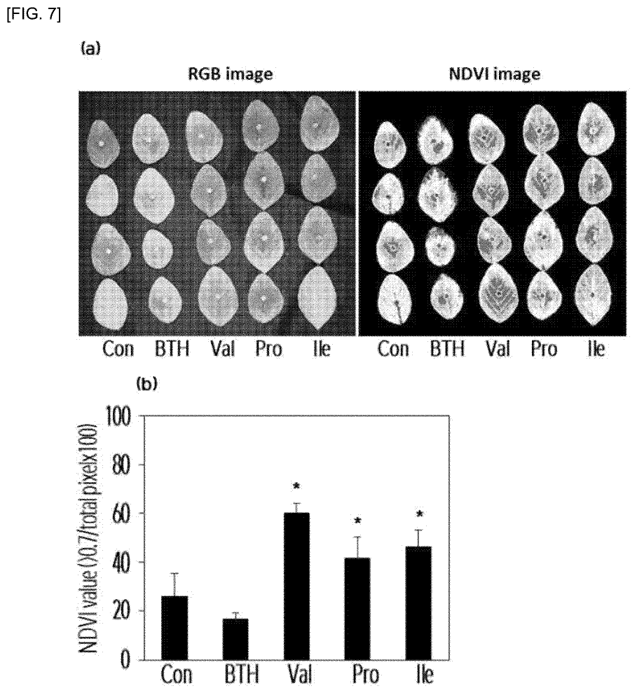

Even in the visible light band, the green color of the untreated group became lighter and the disease progressed more quickly, as compared to the valine-treated group (FIG. 7A, RGB image).

When photographed with the hyperspectral camera, leaves were photographed in different colors depending on the disease severity, in which healthy leaves were green; and the dead leaves were brown (FIG. 7A, NDVI image). In the untreated group, healthy leaves were 26%, whereas the valine-treated group and the isoleucine-treated group had healthy leaves of 60% and 46%, indicating a higher proportion of healthy leaves than the untreated group (FIG. 7B). The hyperspectral camera confirmed again that valine and isoleucine have disease resistance by induced resistance.

### Example 8. Verification of Growth Promoting Ability of Valine

The growth of soybeans and cucumbers was observed by treatment with valine. One week after sowing in pots, root zone treatment of each plant was performed using 5 ml of valine at a concentration of 0.1%. The root zone treatment with valine was performed twice at one week intervals. Two weeks after the last treatment, a shoot of each treatment group was cut and weighed.

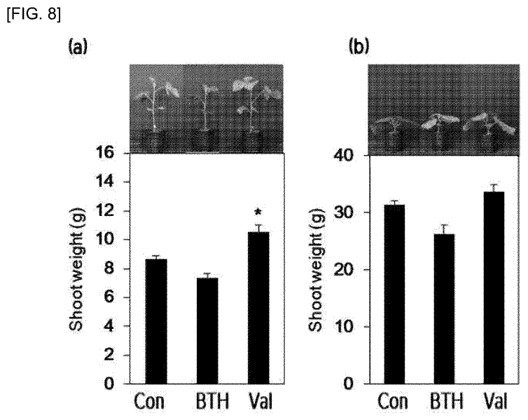

As a result, in the case of soybeans, the valine-treated group was weighed 11 g on average, which was 2.4 g heavier than the untreated group of 8.6 g. In contrast, the BTH-treated group was weighed 7.3 g, showing growth inhibition (FIG. 8A).

In the case of cucumbers, the valine-treated group was weighed 34 g on average, which was 3 g heavier than the untreated group of 31 g. In contrast, the BTH-treated group was weighed 26 g, showing growth inhibition, as compared to the untreated group (FIG. 8B).

The above results suggest that valine also promotes the growth of soybeans and cucumbers.

Based on the above description, it will be understood by those skilled in the art that the present disclosure may be implemented in a different specific form without changing the technical spirit or essential characteristics thereof. In this regard, it should be understood that the above embodiment is not limitative, but illustrative in all aspects. The scope of the disclosure is defined by the appended claims rather than by the description preceding them, and therefore all changes and modifications that fall within metes and bounds of the claims, or equivalents of such metes and bounds are therefore intended to be embraced by the claims.

1-23. (canceled)

24. A method of enhancing plant disease resistance, the method comprising treating a plant body with a composition comprising any one or more selected from the group consisting of branched-chain amino acids, proline, glutamic acid, aspartic acid, and histidine,
wherein the plant disease comprises any one or more selected from the group consisting of leaf spot, bacterial soft rot, Phytophthora stem and root rot, bacterial leaf blight, and rice blast.

25. The method of claim 24, wherein the plant disease is caused by any one or more selected from the group consisting of Pseudomonas syringae pv. tomato, Pectobacterium carotovorum subsp. carotovorum, Phytophthora sojae, Pseudomonas syringae pv. lachrymans, and Magnaporthe oryzae.

26. The method of claim 24, wherein the composition comprises the branched-chain amino acid, and the branched-chain amino acid comprises any one or more selected from the group consisting of isoleucine, leucine, and valine.

27. The method of claim 24, wherein the plant body is of a plant comprising any one or more selected from the group consisting of legumes, fruit vegetables, leafy vegetables, and grains.

28. The method of claim 24, wherein the method prevents or treats an infection of a plant with a pathogen in the plant body.

29. The method of claim 24, wherein the method causes systemic induced resistance of the plant body.

30. The method of claim 24, wherein the method do not inhibit plant growth.

31. The method of claim 24, wherein the composition comprises valine, wherein the plant disease comprises any one or more selected from the group consisting of leaf spot, bacterial soft rot, Phytophthora stem and root rot, bacterial leaf blight, and rice blast.

32. The method of claim 24, wherein the composition comprises isoleucine, wherein the plant disease comprises any one or more selected from the group consisting of leaf spot, bacterial soft rot, Phytophthora stem and root rot, bacterial leaf blight, and rice blast.

33. The method of claim 24, wherein the composition comprises leucine, and the method enhances resistance against leaf spot or bacterial soft rot.

34. The method of claim 24, wherein the composition comprises proline, and the method enhances resistance against leaf spot or bacterial soft rot.

35. The method of claim 24, wherein the composition comprises any one or more selected from the group consisting of glutamic acid, aspartic acid, and histidine, and the method enhances resistance against leaf spot.

36. The method of claim 24, wherein the treating is performed twice or more.

37. The method of claim 24, wherein the treating is performed at intervals of 3 days to 15 days.

38. The method of claim 24, wherein the method promotes plant growth.

39. The method of claim 24, wherein the method prevents or treats a plant disease in the plant body.

40. The method of claim 24, wherein the method controls a plant disease in the plant body.
